(19) United States
(12) Patent Application Publication
(10) Pub. No.: US 2018/0316868 A1
(43) Pub. Date: Nov. 1, 2018

(54) REAR VIEW DISPLAY OBJECT REFERENTS SYSTEM AND METHOD

(71) Applicant: Panasonic Automotive Systems Company of America, Division of Panasonic Corporation of North America, Peachtree City, GA (US)

(72) Inventor: MICHAEL DEAN TSCHIRHART, ANN ARBOR, MI (US)

(73) Assignee: Panasonic Automotive Systems Company of America, Division of Panasonic Corporation of North America

(21) Appl. No.: 15/950,328

(22) Filed: Apr. 11, 2018

Related U.S. Application Data
(60) Provisional application No. 62/490,756, filed on Apr. 27, 2017.

(51) Int. Cl. H04N 5/232; B60R 1/00; H04N 13/20; H04N 5/225; G06T 11/60

(52) U.S. Cl. CPC H04N 5/23296; B60R 1/008; H04N 13/20; H04N 5/2253; G06T 11/60; B60R 2300/605; B60R 2300/303; B60R 2300/8006; B60R 2300/8046; B60R 2300/8066; B60R 2300/105

(57) ABSTRACT

A motor vehicle includes a display screen viewable by a driver of the motor vehicle. A rearview camera captures images of a scene behind the motor vehicle. Means provides video data indicative of a passenger compartment of the motor vehicle as viewed in a rearward direction. An electronic processor is communicatively coupled to the display screen, the rearview camera, and the providing means. The electronic processor provides video content presented on the display screen. The video content is based on the images captured by the rearview camera and on the video data.

### CROSS-REFERENCED TO RELATED APPLICATIONS

This application claims benefit of U.S. Provisional Application No. 62/490,756 filed on Apr. 27, 2017, which the disclosure of which is hereby incorporated by reference in its entirety for all purposes.

### BACKGROUND OF THE INVENTION

### 1. Field of the Invention

The present invention relates to rearview displays in a motor vehicle, and, more particularly, to display-based mirror substitute technologies.

### 2. Description of the Related Art

Display-based mirror substitute technologies like intelligent rearview mirror system (IRMS) enable a range of desirable features and functions to the driver. However, systems that do not visually present traditional structural elements and other factors that facilitate spatial orientation during rearview mirror use may have limited adoption and effectiveness for some users. Most systems employ raw or mildly processed visual display of the rearward view without consideration of these issues.

### SUMMARY OF THE INVENTION

The present invention may provide display-based alternatives to the traditional rear-view mirror (e.g., IRMS). The invention may provide a more natural and desirable functionality to display-based mirror substitute technologies.

The invention may include particular visual elements on a display-based remote (e.g., rear view) visual imaging system in order to provide an enhanced visual frame of reference to the viewer. Several embodiments of the invention are described.

In one embodiment, a predetermined image of a fixed structure is presented on the display. For example, a visual representation of the approximate position of the seats, including head rests, and vehicle structural elements (for example, B and C-pillars of the vehicle) are presented for simple visual reference, as they would he seen in a conventional rearview mirror. This embodiment can be implemented in the rear-view imaging system without requiring additional cameras, image processing or associated resources. This embodiment can be implemented based on known geometric characteristics of the target vehicle interior/exterior/structure.

In another embodiment, a real-time image of interior elements (corresponding to traditional rear-view-mirror-viewable elements from an appropriately positioned camera) is superimposed/presented simultaneously as a separate visual layer. The real-time image of interior elements may be arranged in coordination, and in combination, with the rearward view image to simulate key elements of a naturalistic mirror view.

In yet another embodiment, a predetermined image, or a real-time image, is constructed according to one of the two embodiments described above in conjunction with image processing to render the elements semi-transparent/partially opaque while preserving key aspects of their structure and/or position (e.g., the object outline). In this embodiment, the driver gets the benefit of the view enabled by the rear viewing camera and visual referents without the normal occlusion drawbacks associated with normal (e.g., non-transparent) objects.

In one embodiment, the present invention comprises a motor vehicle including a display screen viewable by a driver of the motor vehicle. A rearview camera captures images of a scene behind the motor vehicle. Means provides video data indicative of a passenger compartment of the motor vehicle as viewed in a rearward direction. An electronic processor is communicatively coupled to the display screen, the rearview camera, and the providing means. The electronic processor provides video content presented on the display screen. The video content is based on the images captured by the rearview camera and on the video data.

In another embodiment, the present invention comprises a motor vehicle including a display screen viewable by a driver of the motor vehicle. A rearview camera captures images of a scene behind the motor vehicle. Means provides video data indicative of a passenger compartment of the motor vehicle as viewed in a rearward direction. An electronic processor is communicatively coupled to the display screen, the rearview camera, and the providing means. The electronic processor provides video content presented on the display screen. The video content includes at least part of the captured images of the scene behind the motor vehicle. The video content also includes semi-transparent or partially opaque representations of objects within the passenger compartment of the motor vehicle.

In yet another embodiment, the present invention comprises a motor vehicle including a display screen viewable by a driver of the motor vehicle. A first camera captures images of a scene behind the motor vehicle. A second camera captures images of the passenger compartment as viewed in a rearward direction from the display screen. An electronic processor is communicatively coupled to the display screen, the first camera, and the second camera. The electronic processor provides video content presented on the display screen. The video content is based on the images captured by the first camera and on the images captured by the second camera.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a rearview display arrangement of the present invention.

FIG. 2A is an example rearview image viewable with a conventional IRMS of the prior art.

FIG. 2B is an example image viewable in a conventional rearview mirror of the prior art.

FIG. 2C is an example image viewable with the rearview display arrangement of FIG. 1.

FIG. 3 is a plan view of a field of view of the display camera of the rearview display arrangement of FIG. 1, and the portion of the field of view that is displayed on the display screen of the rearview display arrangement of FIG. 1, according to another embodiment of the invention.

FIG. 4 is an overhead view of locations of the rearview display and the rearview camera of the rearview display arrangement of FIG. 1.

### DETAILED DESCRIPTION OF DRAWINGS

The embodiments hereinafter disclosed are not intended to be exhaustive or limit the invention to the precise forms disclosed in the following description. Rather the embodiments are chosen and described so that others skilled in the art may utilize its teachings.

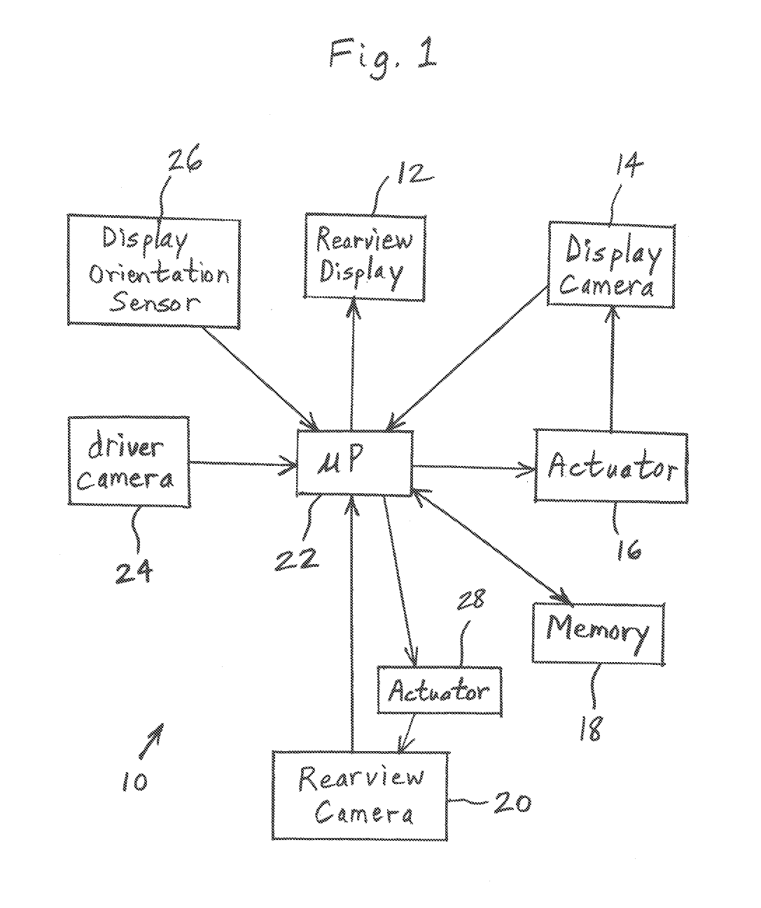

FIG. 1 illustrates one embodiment of a rearview display arrangement 10 of the present invention for a motor vehicle, including a rearview display screen 12, a display camera 14, a first actuator 16, a memory device 18, a rearview camera 20, an electronic processor 22, a driver camera 24, a display screen orientation sensor 26, and a second actuator 28. Rearview display 12 may include an adjustable mount (not shown) which may be manually adjusted by the driver in order to change the orientation of display screen 12 in three-dimensional space. For example, display screen 12 may have a flat viewable surface, and the driver may change the direction in which the viewable surface faces by manually moving the adjustable mount in three-dimensional space. Display orientation sensor 26 may detect the orientation of display screen 12 and transmit to processor 22 signals which are indicative of the three-dimensional orientation of display screen 12.

Driver camera 24 may capture images of a human driver of the vehicle, and particularly of the eyes of the driver. Processor 22 may receive the images captured by camera 24 and determine therefrom the position of the driver, the driver's head, and/or the driver's eyes.

Display camera 14 may have a field of view directed rearward in the passenger compartment from rearview display screen 12, and may capture images of fixed objects disposed between rearview display screen 12 and the rear window of the vehicle. Display camera 14 may be disposed within display screen 12 or closely adjacent to display screen 12 such that display camera 14 may have approximately the same field of view as a hypothetical conventional rearview mirror disposed in the same place as display screen 12. Thus, display camera 14 may capture images of fixed objects within the passenger compartment from a viewpoint that matches how the fixed objects would be presented by a conventional rearview mirror.

Actuator 16 may change the orientation of display camera 14 under the control of processor 22. After processor 22 determines the location of the head and/or eyes of the driver based on images captured by driver camera 24, and determines the orientation of rearview display 12 based on signals from orientation sensor 26, processor 22 may calculate based thereon the field of view within the passenger compartment that the driver would see with a conventional rearview mirror with the same orientation as rearview display 12. Further, processor 22 may calculate the three-dimensional orientation of display camera 14 that would enable display camera 14 to capture the same view of the passenger compartment that would be achieved by a conventional rearview mirror, given the current locations of the driver's eyes, and given the current orientation of rearview display 12. Processor 22 may then transmit control signals to actuator 16 to cause actuator 16 to rotate display camera 14 to the calculated three-dimensional orientation. Similarly, processor 22 may transmit control signals to actuator 28 to cause actuator 16 to rotate rearview camera 20 to an orientation that corresponds to the current locations of the driver's eyes and the current orientation of rearview display 12.

Rearview camera 20 may be attached to a rear end of the vehicle, and may capture images of a scene behind the vehicle. Rearview camera 20 may have a field of view similar to the field of view of a conventional rearview mirror.

Actuators 16 and 28, under the control of processor 16, may be capable of pivoting display camera 14 and rearview camera 20, respectively, both about a respective vertical axis and about a respective horizontal axis that is perpendicular to the forward and rearward directions in which the vehicle generally travels. Thus, actuators 16, 28 may pivot display camera 14 and rearview camera 20, respectively, to emulate the driver moving his head both laterally and vertically.

Memory device 18 may store images of objects within the vehicle passenger compartment from the viewpoint of rearview display 12. Memory device 18 may store only a single image of the objects within the vehicle passenger compartment, or may store any number of images of the objects, with each image being stored in association with a respective orientation of rearview display 12 and/or in association with a respective position of the driver's head or eyes. Mirror images of the images from the viewpoint of rearview display 12 may be stored in order to emulate the view that a driver would see in a conventional mirror.

In one embodiment, processor 22 may receive signals transmitted by display orientation sensor 26, change the orientation of rearview camera 20 to correspond to the orientation of display screen 12, and present a mirror image of each of the images captured by rearview camera 20 on display screen 12. A mirror image of the captured image is presented in order to emulate the view that a driver would see in a conventional mirror. The orientation of camera 20 as it captures images the mirror images of which are displayed on screen 12 may vary depending upon the three-dimensional orientation of display screen 12, as determined by processor 22. Processor 22 may determine the orientation of display screen 12 based on signals transmitted by orientation sensor 26.

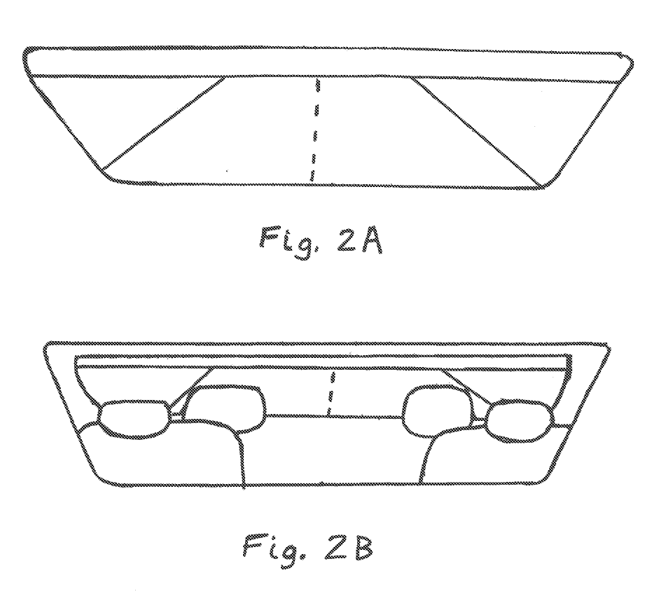

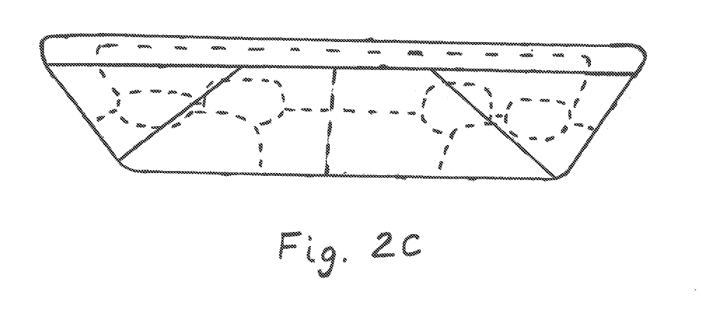

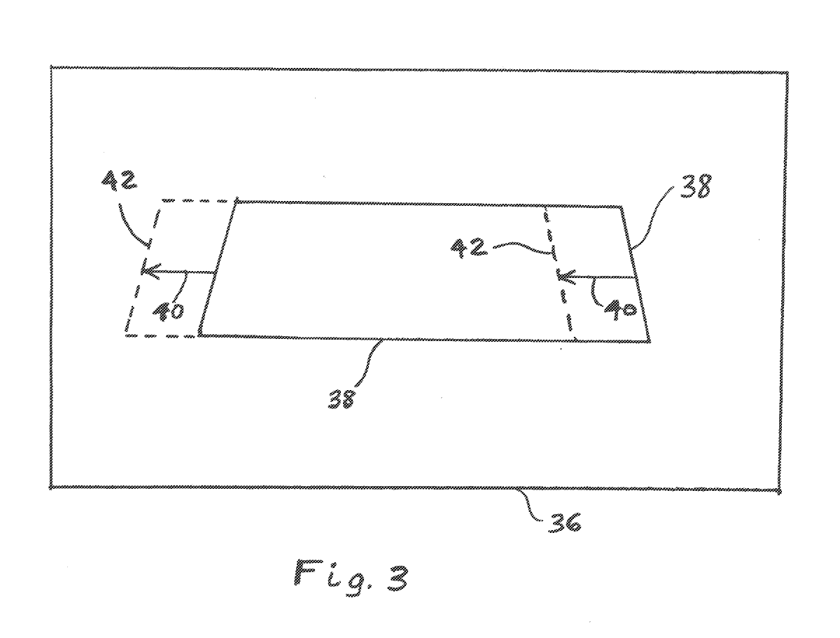

FIG. 2A is an example rearview image viewable with a conventional IRMS of the prior art. This rearview image may be captured by a rearview camera mounted on a rear bumper of the vehicle, and thus the image does not include any obstructions or points of reference, such as a frame of the vehicle's rear window, or seats within the passenger compartment.

FIG. 2B is an example image viewable in a conventional rearview mirror of the prior art. The frame of the vehicle's rear window and the seats within the passenger compartment are visible.

FIG. 2C is an example image viewable with rearview display arrangement 10 of FIG. 1. This image shows the same scene behind the vehicle as captured by rearview camera 20 and as shown with the IRMS of FIG. 2A. The image of FIG. 2C also shows, in dashed lines, the frame of the vehicle's rear window and the seats within the passenger compartment. Instead of outlines of the vehicle's rear window and the seats being shown in dashed lines, the vehicle's rear window and the seats may be shown as being semi-transparent or partially opaque.

The locations of the frame of the vehicle's rear window and the seats within the passenger compartment may be based on mirror images of images captured by display camera 14. Alternatively, the locations of the frame of the vehicle's rear window and the seats within the passenger compartment may be stored in and retrieved from memory device 18. There may be many different sets of data describing the locations of the frame of the vehicle's rear window and the seats. These sets of data may each be stored in memory device 18 in association with a respective orientation of rearview display 12 and/or a respective position of the driver's eyes. Which of these sets of data is retrieved from memory device 18 and is used to create the image displayed on display screen 12 may depend upon the current orientation of rearview display 12 and/or the current position of the driver's eyes.

In another embodiment, instead of actuator 16 reorienting display camera 14 in response to rotation of display screen 12, processor 22 may receive the images captured by a stationary display camera 14, and present a portion of a mirror image of each of the images on display screen 12. A mirror image of the captured image is presented in order to emulate the view that a driver would see in a conventional mirror. The portions of the mirror images of the captured images that are displayed on screen 12 may vary depending upon the three-dimensional orientation of display screen 12, as determined by processor 22. Processor 16 may determine the orientation of display screen 12 based on signals transmitted by display orientation sensor 26.

FIG. 3 illustrates a mirror image 36 of a field of view of display camera 14 according to the embodiment of the previous paragraph, and the portion 38 of the mirror image 36 of the field of view that is displayed on display screen 12. Display camera 14 may capture images of the entire field of view 36, but processor 22 may transmit a video signal to display screen 12 that includes only portion 38. The video signal may include mirror images of the actual captured images to emulate the reflection of a conventional mirror.

As the driver rotates display screen 12 in a counterclockwise rotational direction, as defined from a downward viewing perspective, processor 22 may shift displayed portion 38 of mirror image 36 of the field of view leftward, as indicated by arrows 40, and by the dashed lines 42 indicating the shifted position of portion 38. The leftward movement of portion 38 in response to the rotation of display screen 12 in the counterclockwise direction emulates the changing view that a driver would see in a conventional mirror. Conversely, if the driver were to rotate display screen 12 in the clockwise rotational direction, as defined from the downward viewing perspective, portion 38 would shift rightward. Further, if the driver were to rotate display screen 12 to face more upwardly, portion 38 would shift upward; and if the driver were to rotate display screen 12 to face more downwardly, portion 38 would shift downward.

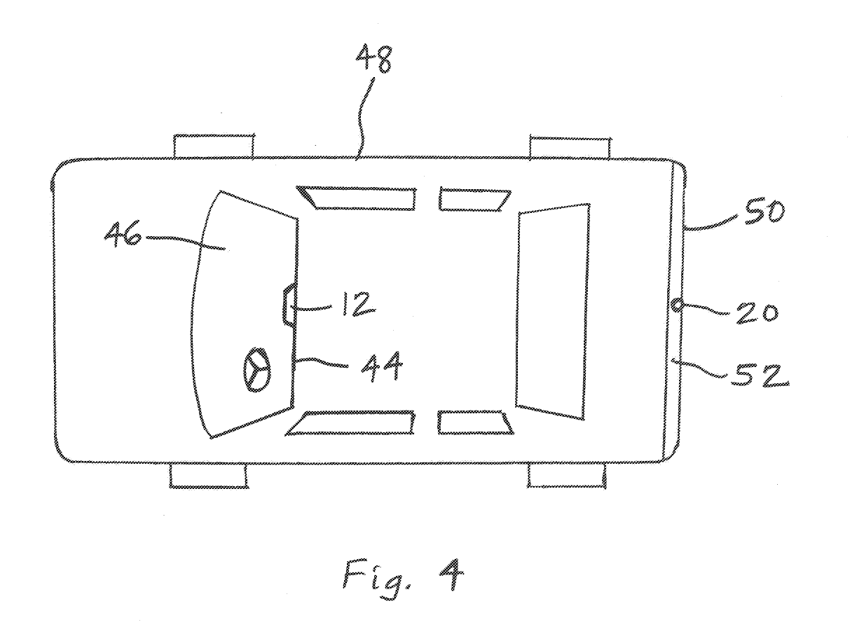

FIG. 4 illustrates locations of rearview display 12 and rearview camera 20 of rearview display arrangement 10. Rearview display 12 may be disposed approximately at a midpoint of a top edge 44 of a windshield 46 of a motor vehicle 48. Rearview camera 20 may be attached to a rear end 50 of motor vehicle 48, such as on a rear bumper 52 of vehicle 48.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle comprising:
a display screen viewable by a driver of the motor vehicle;
a rearview camera configured to capture images of a scene behind the motor vehicle;
means for providing video data indicative of a passenger compartment of the motor vehicle as viewed in a rearward direction; and
an electronic processor communicatively coupled to the display screen, the rearview camera, and the providing means, the electronic processor being configured to provide video content presented on the display screen, the video content being based on the images captured by the rearview camera and on the video data.

2. The motor vehicle of claim 1, wherein the providing means comprises a second camera configured to capture images of the passenger compartment as viewed in a rearward direction from the display screen.

3. The motor vehicle of claim 2, wherein the electronic processor is configured to control the video content presented on the display screen by changing a three-dimensional orientation of the second camera.

4. The motor vehicle of claim 1 wherein the providing means comprises a memory device storing the video data indicative of a passenger compartment of the motor vehicle as viewed in the rearward direction.

5. The motor vehicle of claim 4 further comprising a display orientation sensor configured to detect a three-dimensional orientation of the display screen and transmit an orientation signal to the electronic processor, the orientation signal being indicative of the detected three-dimensional orientation of the display screen, wherein the memory device stores the video data as a plurality of sets of video data, each said set of video data being stored in association with a respective three-dimensional orientation of the display screen.

6. The motor vehicle of claim 4 further comprising a driver camera configured to capture images of a human driver of the motor vehicle and transmit the images of the human driver to the electronic processor, the electronic processor being configured to determine a position of the human driver's head or eyes based on the images of the human driver, wherein the memory device stores the video data as a plurality of sets of video data, each said set of video data being stored in association with a respective position of the human driver's head or eyes.

7. The motor vehicle of claim 1 wherein the display screen is disposed approximately at a midpoint of a top edge of a windshield of the motor vehicle.

8. The motor vehicle of claim 1 wherein the rearview camera is attached to a rear end of the motor vehicle.

9. A motor vehicle comprising:
a display screen viewable by a driver of the motor vehicle;
a rearview camera configured to capture images of a scene behind the motor vehicle;
means for providing video data indicative of a passenger compartment of the motor vehicle as viewed in a rearward direction; and
an electronic processor communicatively coupled to the display screen, the rearview camera, and the providing means, the electronic processor being configured to provide video content presented on the display screen, the video content including at least part of the captured images of the scene behind the motor vehicle, the video content also including semi-transparent or partially opaque representations of objects within the passenger compartment of the motor vehicle.

10. The motor vehicle of claim 9, wherein the providing means comprises a second camera configured to capture images of the passenger compartment as viewed in a rearward direction from the display screen.

11. The motor vehicle of claim 10, wherein the electronic processor is configured to control the video content presented on the display screen by changing a three-dimensional orientation of the second camera.

12. The motor vehicle of claim 9 wherein the providing means comprises a memory device storing the video data indicative of a passenger compartment of the motor vehicle as viewed in the rearward direction.

13. The motor vehicle of claim 12 further comprising a display orientation sensor configured to detect a three-dimensional orientation of the display screen and transmit an orientation signal to the electronic processor, the orientation signal being indicative of the detected three-dimensional orientation of the display screen, wherein the memory device stores the video data as a plurality of sets of video data, each said set of video data being stored in association with a respective three-dimensional orientation of the display screen.

14. The motor vehicle of claim 12 further comprising a driver camera configured to capture images of a human driver of the motor vehicle and transmit the images of the human driver to the electronic processor, the electronic processor being configured to determine a position of the human driver's head or eyes based on the images of the human driver, wherein the memory device stores the video data as a plurality of sets of video data, each said set video data being stored in association with a respective position of the human driver's head or eyes.

15. The motor vehicle of claim 9 wherein the display screen is disposed approximately at a midpoint of a top edge of a windshield of the motor vehicle.

16. The motor vehicle of claim 9 wherein the rearview camera is attached to a rear end of the motor vehicle.

17. A motor vehicle comprising:
a display screen viewable by a driver of the motor vehicle;
a first camera configured to capture images of a scene behind the motor vehicle;
a second camera configured to capture images of the passenger compartment as viewed in a rearward direction from the display screen; and
an electronic processor communicatively coupled to the display screen, the first camera, and the second camera, the electronic processor being configured to provide video content presented on the display screen, the video content being based on the images captured by the first camera and on the images captured by the second camera.

18. The motor vehicle of claim 17 wherein outlines of objects within the passenger compartment are included within the video content, detail of the objects within the outlines being omitted from the video content.

19. The motor vehicle of claim 17 wherein the video content includes semi-transparent or partially opaque representations of objects within the passenger compartment of the motor vehicle.

20. The motor vehicle of claim 17 wherein the display screen is disposed approximately at a midpoint of a top edge of a windshield of the motor vehicle.
